(19) United States
(12) Patent Application Publication
(10) Pub. No.: US 2025/0384818 A1
(43) Pub. Date: Dec. 18, 2025

(54) PIXEL, DISPLAY DEVICE INCLUDING THE SAME AND ELECTRONIC DEVICE INCLUDING DISPLAY DEVICE

(71) Applicant: Samsung Display Co., Ltd., Yongin-si (KR)

(72) Inventors: Sun Hwa LEE, Yongin-si (KR); Hyeong Seok KIM, Yongin-si (KR); Hee Jean PARK, Yongin-si (KR); Mu Kyung JEON, Yongin-si (KR); Kyoung Seok SON, Yongin-si (KR)

(21) Appl. No.: 19/097,686

(22) Filed: Apr. 1, 2025

(30) Foreign Application Priority Data
Jun. 18, 2024 (KR) 10-2024-0078722
Aug. 20, 2024 (KR) 10-2024-0111443

(51) Int. Cl. G09G 3/32

(52) U.S. Cl. CPC G09G 3/32; G09G 2300/0465; G09G 2300/0819

(57) ABSTRACT

A display device includes: a substrate; a first transistor on the substrate; a second transistor on the first transistor and overlapping the first transistor; and an anode electrode on the second transistor and connected to the first transistor, wherein the first transistor includes: a first active pattern on the substrate; and a gate electrode on the first active pattern and overlapping the first active pattern, and wherein the second transistor includes: a first lower electrode on the gate electrode; an upper electrode on the first lower electrode and including a first opening that overlaps the first lower electrode; a second active pattern on the upper electrode and connected to the first lower electrode through the first opening; and a first gate wiring on the second active pattern and overlapping the second active pattern.

### CROSS-REFERENCE TO RELATED APPLICATIONS

The present application claims priority to and the benefit of Korean Patent Application No. 10-2024-0078722, filed on Jun. 18, 2024, in the Korean Intellectual Property Office, and Korean Patent Application No. 10-2024-0111443, filed on Aug. 20, 2024, in the Korean Intellectual Property Office, the entire content of each of which is incorporated herein by reference.

### BACKGROUND

### 1. Field

One or more embodiments of the present invention relate to a display device, for example, relate to a pixel, a display device including the pixel, and an electronic device including the display device.

### 2. DESCRIPTION OF THE RELATED ART

With the growing interest in information displays, research and development of display devices have been continuously and actively pursued (conducted).

### SUMMARY

One or more aspects of embodiments of the present disclosure are directed toward a high-resolution display device with improved pixel integration density.

One or more aspects of embodiments of the present disclosure are directed toward a pixel included in a display device and/or an electronic device.

Additional aspects will be set forth in part in the description which follows and, in part, will be apparent from the description, or may be learned by practice of the presented embodiments.

According to one or more embodiments of the present disclosure, a display device includes: a substrate; a first transistor on (e.g., arranged on) the substrate; a second transistor on (e.g., arranged on) the first transistor and overlapping the first transistor; and an anode electrode on (e.g., arranged on) the second transistor and connected to the first transistor, wherein the first transistor includes a first active pattern on (e.g., arranged on) the substrate; and a gate electrode on (e.g., arranged on) the first active pattern and overlapping the first active pattern, and the second transistor includes a first lower electrode on (e.g., arranged on) the gate electrode; an upper electrode on (e.g., arranged on) the first lower electrode and including a first opening that overlaps the first lower electrode; a second active pattern on (e.g., arranged on) the upper electrode and connected to the first lower electrode through the first opening; and a first gate wiring on (e.g., arranged on) the second active pattern and overlapping the second active pattern.

In one or more embodiments, the first active pattern may include low temperature poly-silicon (LTPS), and the second active pattern may include an oxide semiconductor.

In one or more embodiments, the display device may further include: a first active layer including the first active pattern; a first gate layer including the gate electrode; a second gate layer between (e.g., arranged between) the first gate layer and the first lower electrode; a lower conductive layer including the first lower electrode; an upper conductive layer including the upper electrode; a second active layer including the second active pattern; and a third gate layer including the first gate wiring.

In one or more embodiments, the display device may further include a third transistor on (e.g., arranged on) the same layer as the second transistor.

In one or more embodiments, the third transistor may include: a second lower electrode included in the lower conductive layer and spaced and/or apart (e.g., spaced apart or separated) from the first lower electrode; the upper electrode on (e.g., arranged on) the second lower electrode and including a second opening that overlaps the second lower electrode; a third active pattern included in the second active layer, spaced and/or apart (e.g., spaced apart or separated) from the second active pattern, connected to the second lower electrode through the second opening, and including an oxide semiconductor; and a second gate wiring included in the third gate layer, spaced and/or apart (e.g., spaced apart or separated) from the first gate wiring, and overlapping the third active pattern.

In one or more embodiments, the second gate layer may overlap the gate electrode, and the overlapping gate electrode and second gate layer may form (e.g., constitute) a first capacitor.

In one or more embodiments, the second gate layer may overlap the first lower electrode, and the overlapping second gate layer and first lower electrode may form (e.g., constitute) a second capacitor.

In one or more embodiments, the first lower electrode and the gate electrode may be connected to each other.

In one or more embodiments, the display device may further include a first conductive layer on (e.g., arranged on) the third gate layer and including a power wiring for transmitting an initialization voltage and a data wiring for transmitting a data voltage.

In one or more embodiments, the display device may further include a second conductive layer between (e.g., arranged between) the first conductive layer and the anode electrode.

In one or more embodiments, the lower conductive layer may be connected to the first active layer through at least one first contact hole, and the lower conductive layer may be connected to the second conductive layer through at least one second contact hole.

In one or more embodiments, the first contact hole and the second contact hole may overlap each other.

In one or more embodiments, the data wiring may overlap the upper electrode, and the overlapping upper electrode and data wiring may form (e.g., constitute) a third capacitor.

In one or more embodiments, the display device may further include: a first lower metal layer between (e.g., arranged between) the substrate and the first active layer; and a second lower metal layer between (e.g., arranged between) the first lower metal layer and the first active layer.

In one or more embodiments, the first lower metal layer and the second lower metal layer may overlap each other, and the overlapping first lower metal layer and second lower metal layer may form (e.g., constitute) a fourth capacitor.

In one or more embodiments, the data voltage may be applied to the first lower metal layer, and the second lower metal layer may be electrically connected to the upper conductive layer through the second gate layer.

In one or more embodiments, the second gate layer may be connected to the second lower metal layer through a third contact hole, and may be connected to the upper conductive layer through a fourth contact hole.

In one or more embodiments, the third contact hole and the fourth contact hole may overlap each other.

According to one or more embodiments of the present disclosure, a pixel includes a first transistor connected between a first power voltage node to which a first power voltage is applied and a first node, and having a gate electrode connected to a second node; a second transistor connected between the second node and a third node, and having a gate electrode connected to a first gate line to which a first gate signal is applied; a third transistor connected between the third node and the first node, and having a gate electrode connected to a second gate line to which a second gate signal is applied; a first capacitor connected between an initialization voltage node to which an initialization voltage is applied and the second node; a second capacitor connected between a data line to which a data signal is applied and the third node; and a light-emitting element connected between the first node and a second power voltage node to which a second power voltage is applied, wherein the first transistor is a P-type transistor, and both (e.g., simultaneously) the second and third transistors are N-type transistors.

According to one or more embodiments of the present disclosure, an electronic device includes a processor to provide input image data; and a display device to display an image based on the input image data, the display device incudes: a substrate; a first transistor on the substrate; a second transistor on the first transistor and overlapping the first transistor; and an anode electrode on the second transistor and connected to the first transistor, wherein the first transistor comprises: a first active pattern on the substrate; and a gate electrode on the first active pattern and overlapping the first active pattern, and wherein the second transistor comprises: a first lower electrode on the gate electrode; an upper electrode on the first lower electrode and comprising a first opening that overlaps the first lower electrode; a second active pattern on the upper electrode and connected to the first lower electrode through the first opening; and a first gate wiring on the second active pattern and overlapping the second active pattern.

Specific details of one or more embodiments will be provided in the detailed description and drawings.

According to the above-described embodiments, when the first transistor including poly-silicon and the second transistor including an oxide semiconductor overlap each other in a plan view, and contact holes that are arranged on different layers and share the same electrodes to connect electrically corresponding electrodes overlap each other, the pixel integration density is improved, allowing the implementation of a high-resolution display device. For example, when the first transistor (poly-silicon) and the second transistor (oxide semiconductor) overlap in a plan view, and contact holes on different layers share the same electrodes, the pixel integration density is improved, enabling a high-resolution display device.

Additionally, by increasing the capacitance of the second capacitor connected to the data wiring that transmits the data voltage, the transmission rate of the data voltage transmitted to the first transistor may be improved, and the variation in the transmission rate of the data voltage may be minimized or reduced. For example, increasing the capacitance of the second capacitor connected to the data wiring enhances the transmission rate of the data voltage to the first transistor and minimizes or reduces variations in the transmission rate.

The aspects and/or effects of the embodiments are not limited to those illustrated above, and one or more other aspects and/or effects are further included in this disclosure.

### BRIEF DESCRIPTION OF THE DRAWINGS

The accompanying drawings are included to provide a further understanding of the present disclosure and are incorporated in and constitute a part of this disclosure. The drawings illustrate example embodiments of the disclosure and, together with the description, serve to explain principles of the present disclosure. Above and/or other aspects of the disclosure should become apparent and appreciated from the following description of embodiments taken in conjunction with the accompanying drawings.

FIG. 1 is a block diagram illustrating a display device according to one or more embodiments of the present disclosure.

FIG. 2 is a circuit diagram illustrating one of the sub-pixels of FIG. 1 according to one or more embodiments of the present disclosure.

FIG. 3 is a plan view illustrating a display panel according to one or more embodiments of the present disclosure.

FIG. 4 is a cross-sectional view illustrating one or more embodiments of the display panel of FIG. 3 according to the present disclosure.

FIG. 5 is a cross-sectional view illustrating one or more embodiments of the display panel of FIG. 3 according to the present disclosure.

FIGS. 6-26 are each a layout diagram illustrating an enlarged portion of the display area of the display panel of FIG. 3 according to the present disclosure.

FIG. 27 is a block diagram illustrating a display system according to one or more embodiments of the present disclosure.

FIG. 28 is a perspective view illustrating an application example of the display system of FIG. 27 according to one or more embodiments of the present disclosure.

FIG. 29 is a diagram illustrating a head-mounted display device of FIG. 28 worn by a user according to one or more embodiments of the present disclosure.

### DETAILED DESCRIPTION

Embodiments of the present disclosure may be modified in one or more suitable ways and may have several forms, and example embodiments are illustrated in the drawings and will be described in more detail in the description. However, this is not intended to limit present disclosure to any specific disclosed forms, and it should be understood to include all modifications, equivalents, and substitutes that fall within the spirit and scope of present disclosure.

In describing the drawings, similar reference numerals have been used for similar components. In the accompanying drawings, the dimensions of structures may be illustrated larger than actual sizes for clarity of present disclosure. Terms such as “first,” “second,” and so on may be used to describe one or more suitable components, but these components should not be limited by such terms. These terms are used only to distinguish one component from another. For example, without departing from the scope of present disclosure, a first component may be referred to as a second component, and similarly, a second component may be referred to as a first component.

In this disclosure, terms such as “include(s)/including,” “comprise(s)/comprising,” or “have (has)/having” are intended to specify the presence of features, numbers, steps, operations, components, parts, and/or one or more (e.g., any suitable) combinations thereof described in the specification but do not preclude the possibility of the presence or addition of one or more other features, numbers, steps, operations, components, parts, and/or one or more (e.g., any suitable) combinations thereof. When a layer, film, region, plate, or other element is said to be “on” another element, it includes not only embodiments in which the element is directly on the other element but also embodiments in which there are one or more intervening elements therebetween. In contrast, if (e.g., when) an element is referred to as being “directly on” another element, there are no intervening element present therebetween. In the present disclosure, if (e.g., when) a layer, film, region, plate, or other element is said to be “formed on” another element, the direction of formation is not limited to the upper direction but also includes lateral or downward formation. In addition, if (e.g., when) a layer, film, region, plate, or other element is said to be “under” another element, it includes embodiments in which the element is “directly under” the other element as well as embodiments in which there is an intervening element therebetween.

Hereinafter, the example embodiments of the present disclosure and other details necessary for those skilled in the art to easily understand the content of present disclosure will be described in more detail with reference to the accompanying drawings. In the following description, singular expressions include plural expressions unless it is obvious from the context that they are limited to the singular, for example, the singular forms “a,” “an,” “one,” and “the” are intended to include the plural forms as well, unless the context clearly indicates otherwise. Further, the use of “may” when describing embodiments of the present disclosure refers to “one or more embodiments of the present disclosure.

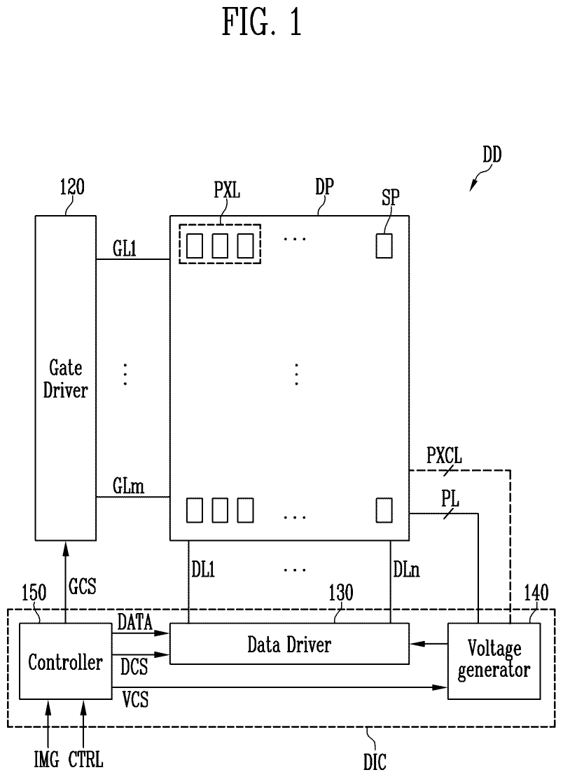

FIG. 1 is a block diagram illustrating a display device according to one or more embodiments of the present disclosure.

Referring to FIG. 1, a display device DD may include a display panel DP, a gate driver 120, a data driver 130, a voltage generator 140, and a controller 150.

The display panel DP includes sub-pixels SP. The sub-pixels SP may be connected to the gate driver 120 via first to m-th gate lines GL1 to GLm. The sub-pixels SP may be connected to the data driver 130 via first to n-th data lines DL1 to DLn.

The sub-pixels SP may generate light in two or more colors. For example, each sub-pixel SP may generate light such as red, green, blue, cyan, magenta, yellow, and/or the like.

Two or more sub-pixels SP may form one pixel PXL. For example, as shown in FIG. 1, in one or more embodiments, a pixel PXL may include three sub-pixels. Thus, the pixel PXL may be to emit light of one or more suitable colors and brightness levels based on the combination of light emitted from each of the sub-pixels included therein.

The gate driver 120 is connected to the sub-pixels SP arranged in a row direction via the first to m-th gate lines GL1 to GLm. The gate driver 120 may output gate signals to the first to m-th gate lines GL1 to GLm in response to a gate control signal GCS. In one or more embodiments, the gate control signal GCS may include a start signal indicating the beginning of each frame, a horizontal synchronization signal, and/or the like.

In one or more embodiments, the gate driver 120 may be arranged on one side of the display panel DP. However, embodiments of the present disclosure are not limited thereto. For example, in one or more embodiments, the gate driver 120 may be divided into two or more drivers, which are physically and/or logically separated, and such drivers may be respectively arranged on one side and another side of the display panel DP. In this way, the gate driver 120 may be arranged around the display panel DP in one or more suitable forms depending on the embodiments.

The data driver 130 is connected to the sub-pixels SP arranged in a column direction via the first to n-th data lines DL1 to DLn. The data driver 130 receives image data DATA and data control signals DCS from the controller 150. The data driver 130 operates in response to the data control signals DCS. In one or more embodiments, the data control signals DCS may include a source start signal, a source shift clock, a source output enable signal, and/or the like.

The data driver 130 may receive voltages from the voltage generator 140. Using the received voltages, the data driver 130 may apply data signals with gradation voltages corresponding to the image data DATA to the first to n-th data lines DL1 to DLn. When a gate signal is applied to each of the first to m-th gate lines GL1 to GLm, data signals corresponding to the image data DATA may be applied to the data lines DL1 to DLn. Accordingly, the sub-pixels SP may generate light corresponding to the data signals, and the display panel DP may display an image.

In one or more embodiments, the gate driver 120 and the data driver 130 may each include complementary metal-oxide semiconductor (CMOS) circuit elements.

The voltage generator 140 may operate in response to voltage control signals VCS from the controller 150. The voltage generator 140 is configured to generate a plurality of voltages and provide the generated voltages to components of the display device DD, such as the gate driver 120, data driver 130, and controller 150. The voltage generator 140 may generate the plurality of voltages by receiving an input voltage from outside the display device DD and regulating the received voltage.

In one or more embodiments, the voltage generator 140 may generate a first power voltage and a second power voltage. The generated first and second power voltages may be provided to the sub-pixels SP via power lines PL. In one or more embodiments, at least one of the first power voltage or the second power voltage may be provided from outside the display device DD.

Additionally, the voltage generator 140 may provide one or more suitable and/or designed voltages and/or signals. For example, in one or more embodiments, the voltage generator 140 may provide one or more initialization voltages applied to the sub-pixels SP. For example, in one or more embodiments, during a sensing operation to sense the electrical characteristics of transistors and/or light-emitting elements in the sub-pixels SP, a set or predetermined reference voltage may be applied to the first to n-th data lines DL1 to DLn, and the voltage generator 140 may generate and transmit that reference voltage to the data driver 130. For example, during a display operation for displaying an image on the display panel DP, common pixel control signals may be applied to the sub-pixels SP, and the voltage generator 140 may generate those pixel control signals. In one or more embodiments, the voltage generator 140 may provide the pixel control signals to the sub-pixels SP through the pixel control lines PXCL. Although FIG. 1 shows the pixel control lines PXCL connected between the voltage generator 140 and the display panel DP, embodiments of the present disclosure are not limited thereto. For example, in one or more embodiments, the pixel control lines PXCL may be connected between the gate driver 120 and the display panel DP. In such embodiments, the pixel control signals may be transmitted from the voltage generator 140 to the pixel control lines PXCL through the gate driver 120.

The controller 150 may control the overall operations of the display device DD. The controller 150 receives input image data IMG and corresponding control signals CTRL from external sources. In response to the control signals CTRL, the controller 150 may provide gate control signals GCS, data control signals DCS, and voltage control signals VCS.

The controller 150 may convert the input image data IMG to be suitable for the display device DD or the display panel DP and output the image data DATA. In one or more embodiments, the controller 150 may arrange the input image data IMG to be suitable for the sub-pixels SP on a row basis and output the image data DATA.

Two or more components of (e.g., selected from among) the data driver 130, the voltage generator 140, and the controller 150 may be implemented on a single integrated circuit. As shown in FIG. 1, in one or more embodiments, the data driver 130, the voltage generator 140, and the controller 150 may be included in a driver integrated circuit DIC. In these embodiments, the data driver 130, the voltage generator 140, and the controller 150 may be functionally separated components within a single driver integrated circuit DIC. In one or more embodiments, at least one of the data driver 130, the voltage generator 140, or the controller 150 may be provided as a component separate from the driver integrated circuit DIC.

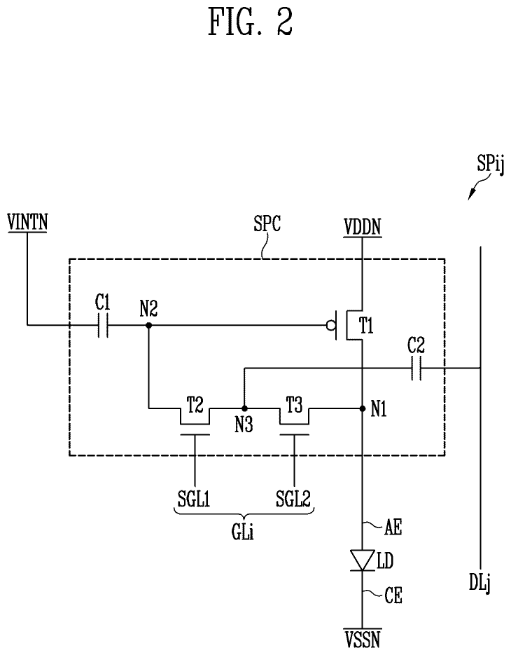

FIG. 2 is a circuit diagram illustrating one of the sub-pixels of FIG. 1 according to one or more embodiments of the present disclosure. In FIG. 2, sub-pixel SPij, arranged in the i-th row (where i is an integer greater than or equal to 1 and less than or equal to m) and the j-th column (where j is an integer greater than or equal to 1 and less than or equal to n) of the sub-pixels SP of FIG. 1, is illustratively shown.

Referring to FIG. 2, the sub-pixel SPij may include a sub-pixel circuit SPC and a light-emitting element LD.

The light-emitting element LD is connected between a first power voltage node VDDN and a second power voltage node VSSN. The first power voltage node VDDN is connected to a first power line among the power lines PL of FIG. 1, receiving a first power voltage supplied from the first power line. The second power voltage node VSSN is connected to a second power line, which is different from the first power line among the power lines PL of FIG. 1, receiving a second power voltage supplied from the second power line. The first power voltage may have a higher voltage level than the second power voltage.

The light-emitting element LD is connected between an anode electrode AE and a cathode electrode CE. The anode electrode AE may be connected to the first power voltage node VDDN through the sub-pixel circuit SPC. For example, the anode electrode AE may be connected to the first power voltage node VDDN through one or more transistors included in the sub-pixel circuit SPC. The cathode electrode CE may be connected to the second power voltage node VSSN. The light-emitting element LD is configured to emit light based on an current flowing from the anode electrode AE to the cathode electrode CE.

The sub-pixel circuit SPC may be connected to the i-th gate line GLi among the first to m-th gate lines GL1 to GLm of FIG. 1, and to the j-th data line DLj among the first to n-th data lines DL1 to DLn of FIG. 1. The sub-pixel circuit SPC is configured to control the light-emitting element LD based on signals received through these signal lines.

The sub-pixel circuit SPC may operate in response to a gate signal received through the i-th gate line GLi. The i-th gate line GLi may include one or more sub-gate lines. In one or more embodiments, as shown in FIG. 2, the i-th gate line GLi may include first and second sub-gate lines SGL1 and SGL2. The sub-pixel circuit SPC may operate in response to gate signals received through the first and second sub-gate lines SGL1 and SGL2. Thus, if (e.g., when) the i-th gate line GLi includes two or more sub-gate lines, the sub-pixel circuit SPC may operate in response to gate signals received through those sub-gate lines.

The sub-pixel circuit SPC may receive a data signal through the j-th data line DLj. The sub-pixel circuit SPC may store a voltage corresponding to the data signal in response to at least one of the gate signals received through the first and second sub-gate lines SGL1 and SGL2.

To perform these operations, the sub-pixel circuit SPC may include pixel circuits, such as transistors and one or more capacitors.

The transistors of the sub-pixel circuit SPC may include P-type (P) transistors and/or N-type (N) transistors. In one or more embodiments, the transistors of the sub-pixel circuit SPC may include metal oxide silicon field effect Transistors (MOSFETs). In one or more embodiments, the transistors of the sub-pixel circuit SPC may include amorphous silicon semiconductors, monocrystalline silicon semiconductors, polycrystalline silicon semiconductors, oxide semiconductors, and/or the like.

For example, in one or more embodiments, the sub-pixel circuit SPC may include first to third transistors T1 to T3 and first and second capacitors C1 and C2.

The first transistor T1 may be connected between the first power voltage node VDDN and a first node N1. In addition, the first transistor T1 may have a gate electrode connected to a second node N2. For example, in one or more embodiments, the first transistor T1 may be a driving transistor that generates driving current. In these embodiments, the first transistor T1 may be a P-type transistor.

The second transistor T2 may be connected between the second node N2 and a third node N3. In addition, the second transistor T2 may have a gate electrode connected to the first sub-gate line SGL1. For example, in one or more embodiments, a first gate signal received through the first sub-gate line SGL1 may be a write gate signal. In these embodiments, the second transistor T2 may be an N-type transistor.

The third transistor T3 may be connected between the third node N3 and the first node N1. In addition, the third transistor T3 may have a gate electrode connected to the second sub-gate line SGL2. For example, in one or more embodiments, second gate signal received through the second sub-gate line SGL2 may be a compensation gate signal. In these embodiments, the third transistor T3 may be an N-type transistor.

The first capacitor C1 may be connected between an initialization voltage node VINTN, to which an initialization voltage is applied, and the second node N2. The second capacitor C2 may be connected between the data line DLj, to which a data signal is applied, and the third node N3. A transmission rate of the data signal may vary depending on the capacitance of the second capacitor C2. For example, as the capacitance of the second capacitor C2 increases, the transmission rate of the data signal may improve.

Accordingly, the light-emitting element LD may be connected between the first node N1, which is connected to the first transistor T1, and the second power voltage node VSSN, and may generate light with a brightness corresponding to the data signal.

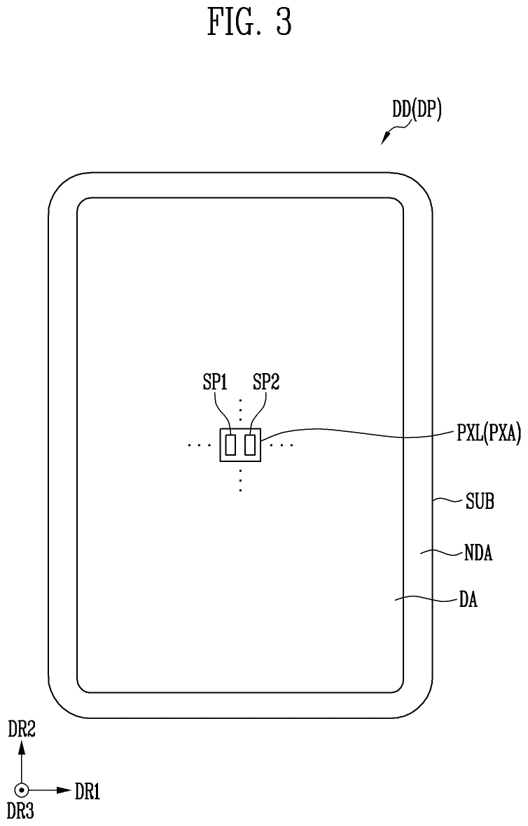

FIG. 3 is a plan view illustrating the display panel of FIG. 1 according to one or more embodiments of the present disclosure.

Referring to FIG. 3, the display panel DP may include a display area DA and a non-display area NDA. The display panel DP displays images through the display area DA. The non-display area NDA is arranged around the display area DA.

The display panel DP includes sub-pixels in the display area DA. The sub-pixels may be arranged in a first direction DR1 and a second direction DR2, which intersects the first direction DR1. Two or more sub-pixels among the plurality of sub-pixels may form one pixel PXL. For the sake of explanation, it is assumed that one pixel PXL includes two sub-pixels SP1 and SP2.

Each of first and second sub-pixels SP1 and SP2 may generate light in one of one or more suitable colors, such as red, green, blue, cyan, magenta, or yellow.

Each of the first and second sub-pixels SP1 and SP2 may include at least one light-emitting element configured to generate light. In one or more embodiments, the light-emitting elements of the first and second sub-pixels SP1 and SP2 may generate light of the same color. For example, the light-emitting elements of the first and second sub-pixels SP1 and SP2 may generate blue light. In one or more embodiments, the light-emitting elements of the first and second sub-pixels SP1 and SP2 may generate light of different colors.

As the display panel DP, a self-emissive display panel such as a light-emitting diode (LED) display panel using micro-scale or nano-scale light-emitting diodes as light-emitting elements, or an organic light-emitting display panel (OLED panel) using organic light-emitting diodes as light-emitting elements may be used.

In the non-display area NDA, components for controlling the sub-pixels SP may be arranged. The wiring connected to the sub-pixels SP, such as the first to m-th gate lines GL1 to GLm, the first to n-th data lines DL1 to DLn, the power lines PL, and the pixel control lines PXCL of FIG. 1, may be arranged in the non-display area NDA.

At least one of the gate driver 120, data driver 130, voltage generator 140, or controller 150 of FIG. 1 may be arranged in the non-display area NDA of the display panel DP. In one or more embodiments, the gate driver 120 may be arranged in the non-display area NDA. In these embodiments, the data driver 130, voltage generator 140, and controller 150 may be implemented as a driver integrated circuit DIC separate from the display panel DP, as shown in FIG. 1, and the driver integrated circuit DIC may be connected to the wiring arranged in the non-display area NDA. In one or more embodiments, the gate driver 120 may be implemented as a single integrated circuit along with the data driver 130, voltage generator 140, and controller 150, separate from the display panel DP.

In one or more embodiments, the display area DA may have one or more suitable shapes. The display area DA may have a closed-loop shape that includes straight and/or curved edges. For example, the display area DA may have a shape such as a polygon, circle, semicircle, or ellipse.

In one or more embodiments, the display panel DP may have a flat display surface. In one or more embodiments, the display panel DP may have a rounded display surface, or at least in part. In one or more embodiments, the display panel DP may be bendable, foldable, or rollable. In these embodiments, the display panel DP and/or the substrate SUB of the display panel DP may include materials with flexible properties.

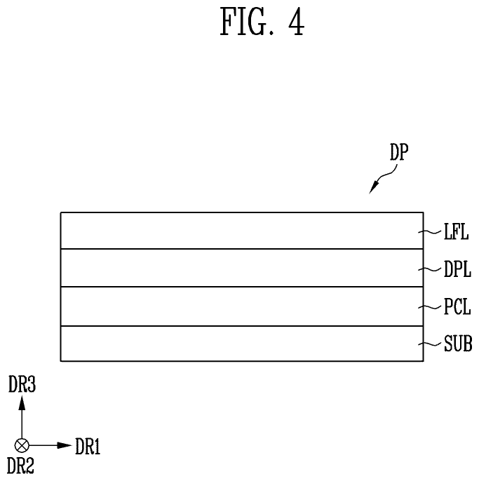

FIG. 4 is a cross-sectional view illustrating the display panel of FIG. 3 according to one or more embodiments of the present disclosure.

Referring to FIG. 4, the display panel DP may include a substrate SUB, and a pixel circuit layer PCL, a display element layer DPL, and a light functional layer LFL, which are sequentially stacked in a third direction DR3 intersecting the first and second directions DR1 and DR2 on the substrate SUB.

The substrate SUB may be made of an insulating material such as glass or a resin. For example, in one or more embodiments, the substrate SUB may include a glass substrate. In one or more embodiments, the substrate SUB may include a polyimide (PI) substrate. In one or more embodiments, the substrate SUB may include a silicon wafer substrate formed using a semiconductor process.

In one or more embodiments, the substrate SUB may be made of a flexible material that allows bending or folding and may have a single-layer or multi-layer structure. For example, the flexible material may include at least one of polystyrene, polyvinyl alcohol, polymethyl methacrylate, polyethersulfone, polyacrylate, polyetherimide, polyethylene naphthalate, polyethylene terephthalate, polyphenylene sulfide, polyarylate, polyimide, polycarbonate, triacetate cellulose, or cellulose acetate propionate. However, embodiments of the present disclosure are not limited to these materials.

The pixel circuit layer PCL is arranged on the substrate SUB. The pixel circuit layer PCL may include insulating layers, and semiconductor electrodes and conductive electrodes arranged between the insulating layers. The conductive electrodes of the pixel circuit layer PCL may function as circuit elements, wiring, and/or the like.

The circuit elements of the pixel circuit layer PCL may include the sub-pixel circuits SPC (see FIG. 2) for each of the sub-pixels SP in FIG. 3. For example, the circuit elements of the pixel circuit layer PCL may be provided as the transistors and one or more capacitors of the sub-pixel circuits SPC.

The wiring of the pixel circuit layer PCL may include the wiring connected to the sub-pixels SP. The wiring of the pixel circuit layer PCL may include one or more suitable signal lines and/or voltage lines necessary for driving the display element layer DPL.

The display element layer DPL is arranged on the pixel circuit layer PCL. The display element layer DPL may include light-emitting elements of the sub-pixels SP.

The light functional layer LFL may be arranged on the display element layer DPL. The light functional layer LFL may include light conversion patterns having color conversion particles and/or scattering particles. For example, the color conversion particles may include quantum dots. Quantum dots may change the wavelength (or color) of the light emitted from the display element layer DPL. In one or more embodiments, the light functional layer LFL may further include light-scattering patterns with scattering particles. In one or more embodiments, the light conversion patterns and light-scattering patterns may not be provided.

In one or more embodiments, the light functional layer LFL may further include a color filter layer containing color filters. The color filters may selectively transmit light of specific wavelengths (or specific colors). In one or more embodiments, the color filter layer may not be provided.

In one or more embodiments, a window may be provided on the light functional layer LFL to protect the exposed surface (or upper surface) of the display panel DP. The window may protect the display panel DP from external impacts. The window may be coupled to the light functional layer LFL through an optically transparent adhesive (or bonding) member. The window may have a multi-layer structure selected from among a glass substrate, a plastic film, and a plastic substrate. This multi-layer structure may be formed through a continuous process or an adhesive process using an adhesive layer. In one or more embodiments, all or part of the window may have flexibility.

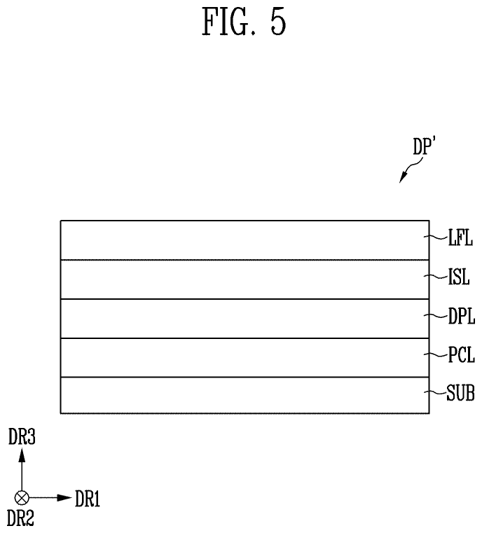

FIG. 5 is a cross-sectional view illustrating the display panel of FIG. 3 according to one or more embodiments of the present disclosure.

Referring to FIG. 5, a display panel DP′ may include a substrate SUB, a pixel circuit layer PCL, a display element layer DPL, an input sensing layer SSL, and a light functional layer LFL. The substrate SUB, the pixel circuit layer PCL, the display element layer DPL, and the light functional layer LFL may each be configured similarly to the substrate SUB, the pixel circuit layer PCL, the display element layer DPL, and the light functional layer LFL described with reference to FIG. 4, respectively. The redundant descriptions will not be provided hereafter.

The input sensing layer SSL may detect user input on an upper surface (or display surface) of the display panel DP′. The input sensing layer SSL may include configurations suitable for detecting external objects such as a user's hand or a pen. For example, in one or more embodiments, the input sensing layer SSL may include touch electrodes.

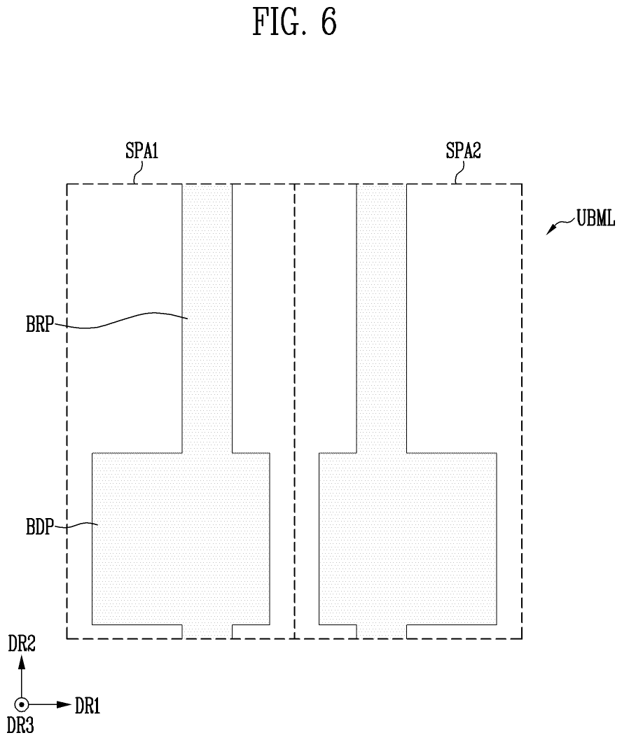

FIGS. 6 to 26 are each a layout diagram showing an enlarged portion of a display area of the display panel of FIG. 3 according to one or more embodiments of the present disclosure. FIGS. 6 to 26 are each a layout diagram showing only the pixel circuit layer PCL of the display panel of FIG. 3.

For example, FIGS. 6 to 26 describe structures arranged in a first sub-pixel area SPA1, and a second sub-pixel area SPA2 adjacent to the first sub-pixel area SPA1, where the first sub-pixel SP1 and the second sub-pixel SP2 of FIG. 3 are placed, respectively. The second sub-pixel SP2 may have a structure that is symmetrical to the structure of the first sub-pixel SP1 with respect to an imaginary symmetry line.

Referring to FIG. 6, a first lower metal layer UBML may be arranged on the substrate. The first lower metal layer UBML may include a body portion BDP and a bridge portion BRP, which are arranged in each of the first and second sub-pixel areas SPA1 and SPA2. The body portion BDP and the bridge portion BRP may be integrally formed. The bridge portion BRP extends in the second direction DR2, and the body portion BDP may be connected to another adjacent sub-pixel in the second direction DR2 via the bridge portion BRP.

The first lower metal layer UBML may receive a data voltage through a second gate layer GAT2, which will be described in more detail later, in the non-display area NDA of FIG. 3. In this regard, the data voltage may represent a value of the data signal transmitted by the data line DLj of FIG. 2.

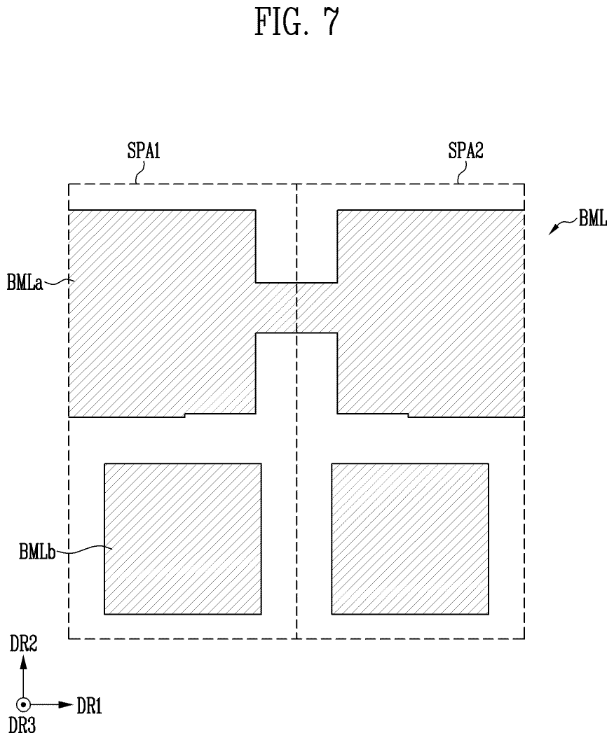

Referring to FIG. 7, a second lower metal layer BML may be arranged on the first lower metal layer UBML. The second lower metal layer BML may include a shielding electrode BMLa arranged in the first and second sub-pixel areas SPA1 and SPA2, and a first capacitor electrode BMLb arranged in each of the first and second sub-pixel areas SPA1 and SPA2.

The shielding electrode BMLa may be connected between the first and second sub-pixel areas SPA1 and SPA2 and may extend to other sub-pixel areas adjacent in the first direction DR1. The first capacitor electrode BMLb may be spaced and/or apart (e.g., spaced apart or separated) from the shielding electrode BMLa and may be arranged in an island shape.

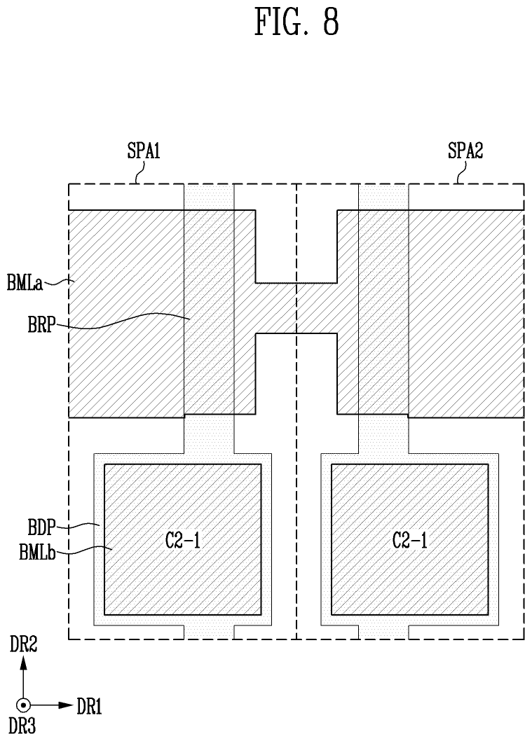

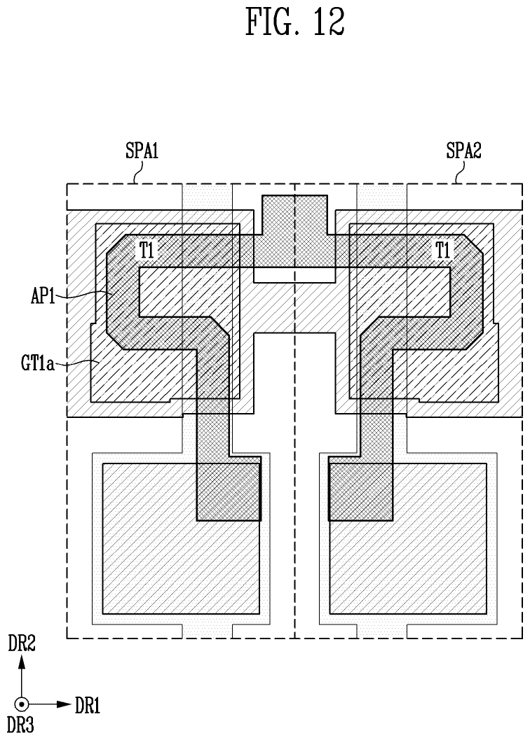

Referring to FIG. 8, the shielding electrode BMLa may shield a first transistor T1 (see FIG. 12), which will be described in more detail later. The shielding electrode BMLa overlaps the first transistor T1 and may shield the first transistor T1 from a plurality of voltages affecting the first transistor T1, such as the data voltage transmitted by the first lower metal layer UBML. Accordingly, the shielding electrode BMLa may ensure the operational reliability of the first transistor T1.

The first lower metal layer UBML and the second lower metal layer BML may overlap each other. For example, the first capacitor electrode BMLb of the second lower metal layer BML may overlap the body portion BDP of the first lower metal layer UBML. The first capacitor electrode BMLb and the body portion BDP may form a second-1 capacitor C2-1. The second-1 capacitor C2-1 may form part of the second capacitor C2 of FIG. 2. In this regard, the first lower metal layer UBML and the second lower metal layer BML may each receive different voltages, resulting in a voltage difference between the first lower metal layer UBML and the second lower metal layer BML. A charge may be stored in the second-1 capacitor C2-1 in proportion to this voltage difference.

In one or more embodiments, the shapes of the first and second lower metal layers UBML and BML may be variously modified. In one or more embodiments, the first and second lower metal layers UBML and BML may not be provided.

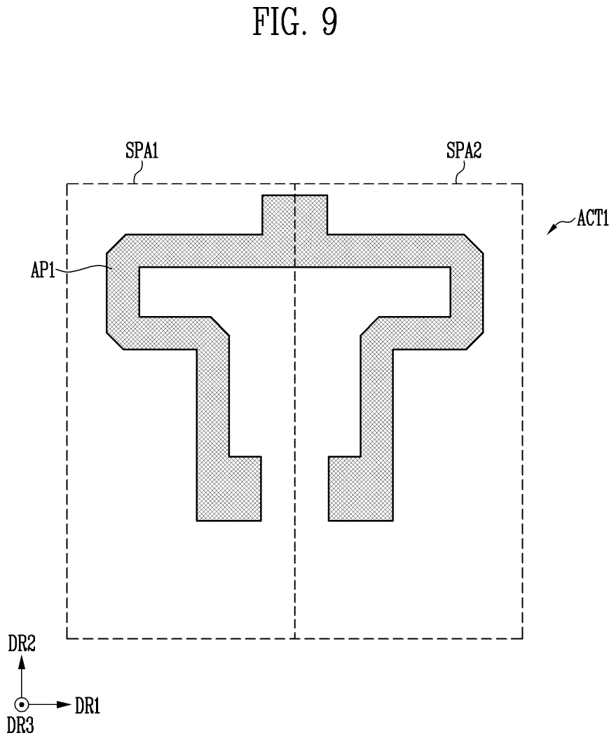

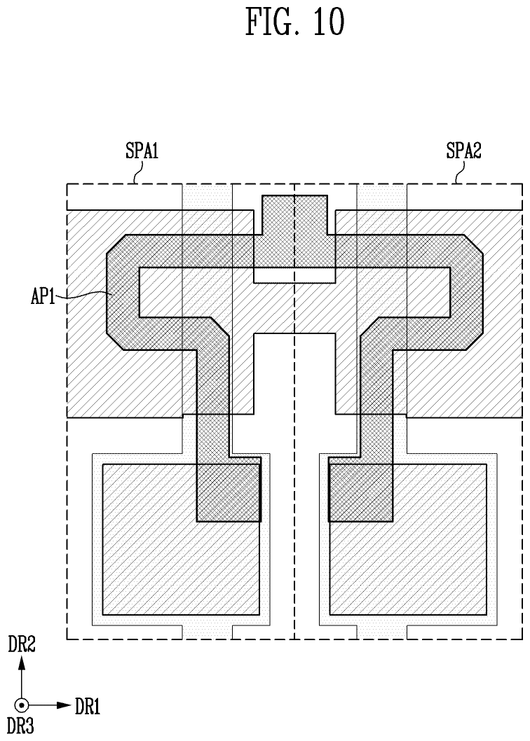

Referring to FIGS. 9 and 10, a first active layer ACT1 may be arranged on the second lower metal layer BML. The first active layer ACT1 may include low-temperature poly-silicon (LTPS).

The first active layer ACT1 may include a first active pattern AP1 arranged in the first and second sub-pixel areas SPA1 and SPA2. The first active pattern AP1 is connected between the first and second sub-pixel areas SPA1 and SPA2 and may be integrally formed. The first active pattern AP1 may form the first transistor T1 of FIG. 2. Because the first transistor T1 is a P-type transistor, the first active pattern AP1 may include a doping region doped with a P-type (kind) dopant.

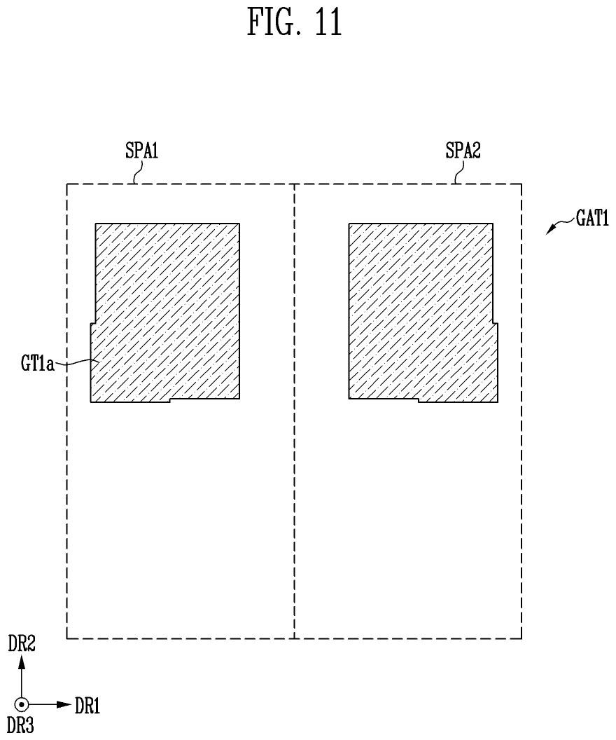

Referring to FIGS. 11 and 12, a first gate layer GAT1 may be arranged on the first active layer ACT1. The first gate layer GAT1 may include a metal, an alloy, a conductive metal oxide, a transparent conductive material, and/or the like. For example, in one or more embodiments, the first gate layer GAT1 may include a metal such as molybdenum (Mo), aluminum (AI), copper (Cu), or titanium (Ti).

The first gate layer GAT1 may include gate electrodes GT1a arranged in each of the first and second sub-pixel areas SPA1 and SPA2. The gate electrodes GT1a may be arranged in an island shape. The gate electrodes GT1a may overlap with the first active pattern AP1. The overlapping gate electrodes GT1a and the first active pattern AP1 may form a first transistor T1.

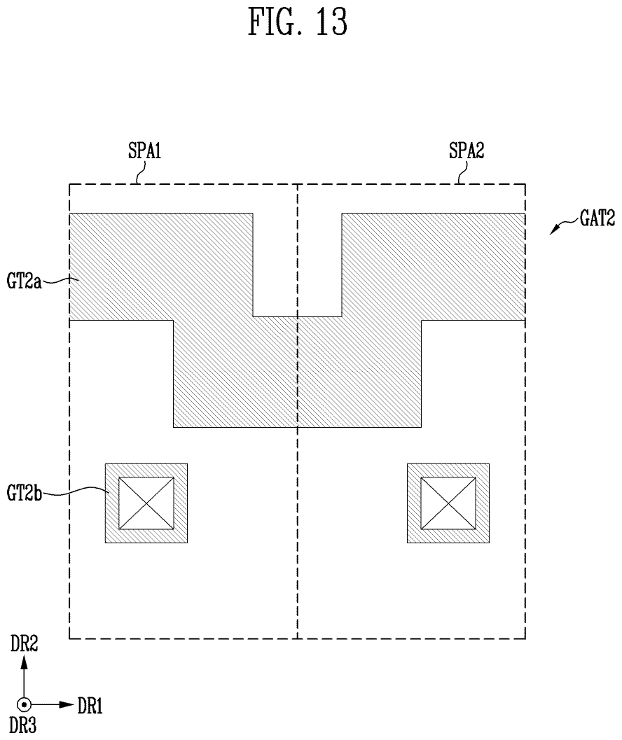

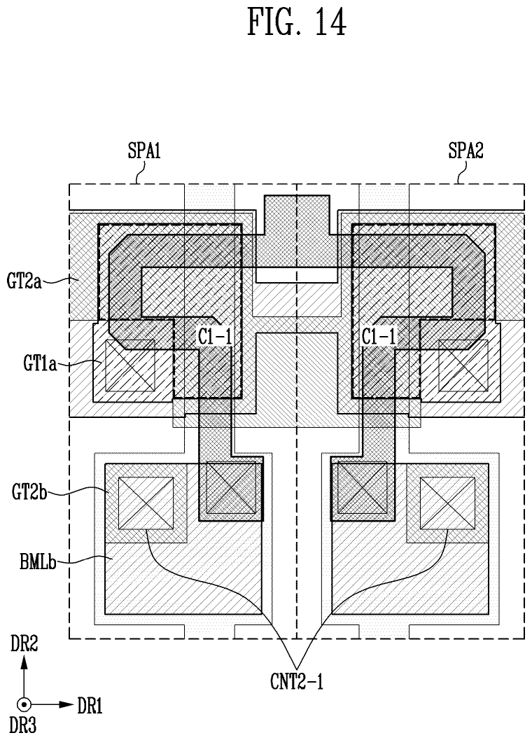

Referring to FIGS. 13 and 14, a second gate layer GAT2 may be arranged on the first gate layer GAT1. The second gate layer GAT2 may include a metal, an alloy, a conductive metal oxide, a transparent conductive material, and/or the like. For example, in one or more embodiments, the second gate layer GAT2 may include a metal such as molybdenum (Mo), aluminum (Al), copper (Cu), or titanium (Ti).

The second gate layer GAT2 may include a second capacitor electrode GT2a arranged in the first and second sub-pixel areas SPA1 and SPA2, and a first connection electrode GT2b arranged in each of the first and second sub-pixel areas SPA1 and SPA2.

The second capacitor electrode GT2a may be connected between the first and second sub-pixel areas SPA1 and SPA2 and may extend to other sub-pixel areas adjacent in the first direction DR1. The second capacitor electrode GT2a is connected to a first power wiring SD1b, which will be described in more detail later, and may receive an initialization voltage through the first power wiring SD1b. In this regard, the initialization voltage may refer to the initialization voltage transmitted through the initialization voltage node VINTN of FIG. 2.

The second capacitor electrode GT2a may overlap with the gate electrode GT1a. The overlapping gate electrode GT1a and the second capacitor electrode GT2a may form a first-1 capacitor C1-1. The first-1 capacitor C1-1 may form part of the first capacitor C1 of FIG. 2. In this regard, the gate electrode GT1a and the second capacitor electrode GT2a may receive different voltages, respectively, resulting in a voltage difference between the gate electrode GT1a and the second capacitor electrode GT2a. A charge may be stored in the first-1 capacitor C1-1 in proportion to this voltage difference.

The first connection electrode GT2b may be spaced and/or apart (e.g., spaced apart or separated) from the second capacitor electrode GT2a and may be arranged in an island shape. The first connection electrode GT2b may be connected to the first capacitor electrode BMLb of the second lower metal layer BML through a second-1 contact hole CNT2-1.

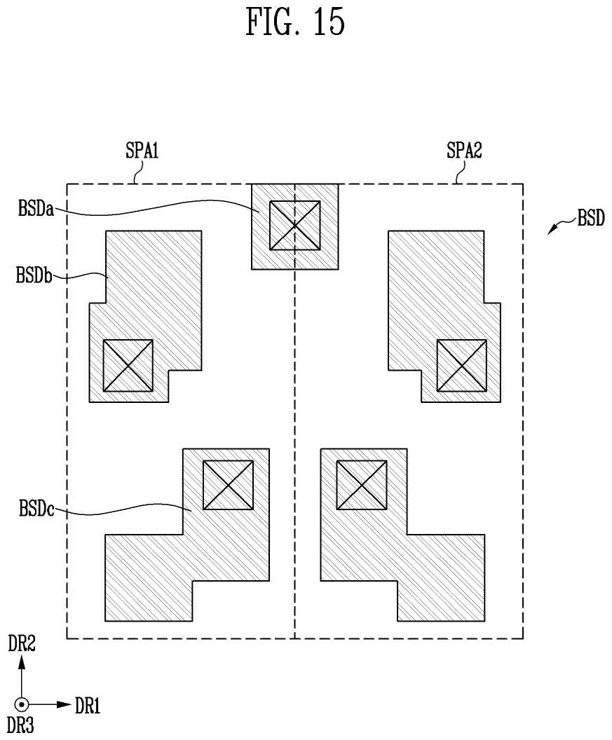

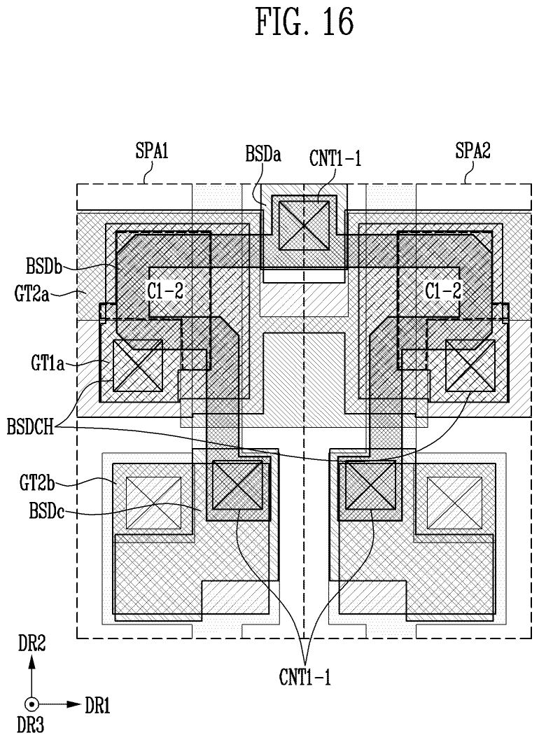

Referring to FIGS. 15 and 16, a lower conductive layer BSD may be arranged on the second gate layer GAT2. The lower conductive layer BSD may include a metal, an alloy, a conductive metal oxide, a transparent conductive material, and/or the like. For example, in one or more embodiments, the lower conductive layer BSD may include a metal such as molybdenum (Mo), aluminum (AI), copper (Cu), or titanium (Ti).

The lower conductive layer BSD may include a second connection electrode BSDa arranged in the first and second sub-pixel areas SPA1 and SPA2, a first lower electrode BSDb arranged in each of the first and second sub-pixel areas SPA1 and SPA2, and a second lower electrode BSDc arranged in each of the first and second sub-pixel areas SPA1 and SPA2.

The second connection electrode BSDa may be arranged across the first and second sub-pixel areas SPA1 and SPA2. The second connection electrode BSDa may be connected to the first active pattern AP1 through a first-1 contact hole CNT1-1.

The first lower electrode BSDb may be spaced and/or apart (e.g., spaced apart or separated) from the second connection electrode BSDa. The first lower electrode BSDb may be arranged on the first transistor T1 and may overlap with the first transistor T1. In addition, the first lower electrode BSDb may form the second transistor T2 of FIG. 2.

The first lower electrode BSDb may partially overlap with the second capacitor electrode GT2a included in the second gate layer GAT2. The overlapping second capacitor electrode GT2a and the first lower electrode BSDb may form a first-2 capacitor C1-2. The first-2 capacitor C1-2 may form part of the first capacitor C1 of FIG. 2. In this regard, the second capacitor electrode GT2a and the first lower electrode BSDb may receive different voltages, resulting in a voltage difference between the second capacitor electrode GT2a and the first lower electrode BSDb. A charge may be stored in the first-2 capacitor C1-2 in proportion to this voltage difference.

In addition, the first lower electrode BSDb may be connected to the gate electrode GT1a through a contact hole BSDCH. For example, the first lower electrode BSDb may have the same voltage as the gate electrode GT1a. Accordingly, the first-1 capacitor C1-1 and the first-2 capacitor C1-2 may be connected in parallel to form a single first capacitor. In this regard, the first capacitor may be provided as the first capacitor C1 of FIG. 2. Because the first-1 capacitor C1-1 and the first-2 capacitor C1-2 are connected in parallel, the first capacitor may have a capacitance that is the sum of the capacitance of the first-1 capacitor C1-1 and the capacitance of the first-2 capacitor C1-2.

The second lower electrode BSDc may be spaced and/or apart (e.g., spaced apart or separated) from the second connection electrode BSDa and the first lower electrode BSDb. In addition, the second lower electrode BSDc may form the third transistor T3 of FIG. 2.

The second lower electrode BSDc may be connected to the first active pattern AP1 through the first-1 contact hole CNT1-1. Accordingly, the lower conductive layer BSD and the first active layer ACT1 may be connected to each other through at least one first-1 contact hole CNT1-1. For example, because the second connection electrode BSDa is connected to the first active pattern AP1 through the first-1 contact hole CNT1-1, and the second lower electrode BSDc is also connected to the first active pattern AP1 through the first-1 contact hole CNT1-1, the lower conductive layer BSD and the first active layer ACT1 in the first and second sub-pixel areas SPA1 and SPA2 included in one pixel may be connected to each other through a total of three first-1 contact holes CNT1-1.

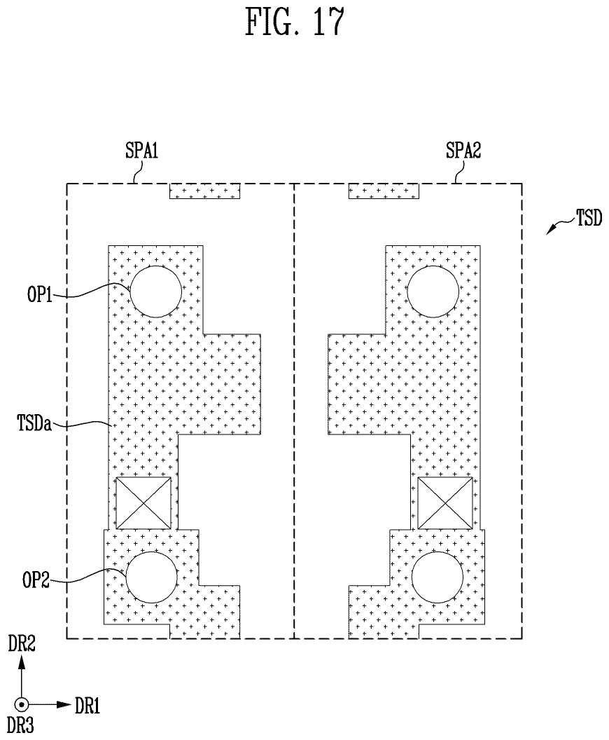

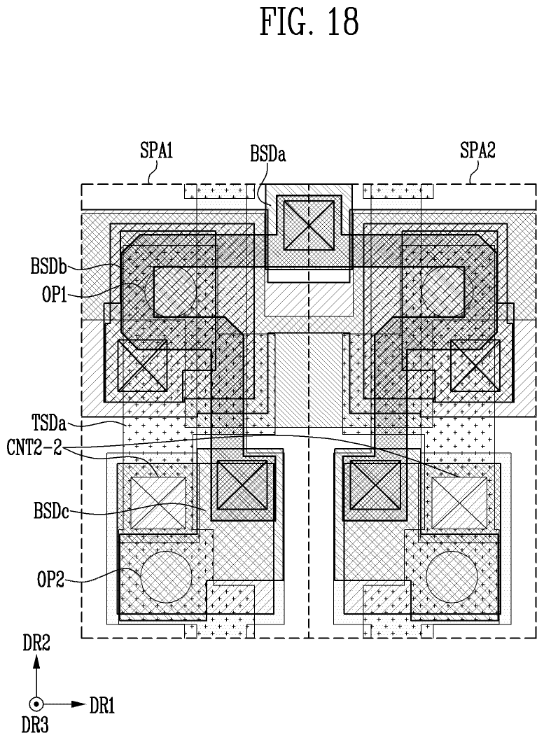

Referring to FIGS. 17 and 18, an upper conductive layer TSD may be arranged on the lower conductive layer BSD. The upper conductive layer TSD may include a metal, an alloy, a conductive metal oxide, a transparent conductive material, and/or the like. For example, in one or more embodiments, the upper conductive layer TSD may include a transparent conductive material such as indium zinc oxide.

The upper conductive layer TSD may include upper electrodes TSDa arranged in each of the first and second sub-pixel areas SPA1 and SPA2. The upper electrodes TSDa may have a shape extending in the second direction DR2.

The upper electrodes TSDa may be arranged on the first and second lower electrodes BSDb and BSDc. The upper electrodes TSDa may overlap the first lower electrode BSDb and, together with the first lower electrode BSDb, may form the second transistor T2 of FIG. 2. Additionally, the upper electrodes TSDa may overlap the second lower electrode BSDc and, together with the second lower electrode BSDc, may form the third transistor T3 of FIG. 2.

The upper electrodes TSDa may include a first opening OP1 overlapping the first lower electrode BSDb and a second opening OP2 overlapping the second lower electrode BSDc. For example, the first lower electrode BSDb may be exposed through the first opening OP1, and the second lower electrode BSDc may be exposed through the second opening OP2.

The upper electrodes TSDa may be connected to the first connection electrode GT2b included in the second gate layer GAT2 through a second-2 contact hole CNT2-2. As a result, the upper electrodes TSDa may be electrically connected to the first capacitor electrode BMLb included in the second lower metal layer BML through the first connection electrode GT2b. Therefore, the upper electrodes TSDa, the first connection electrode GT2b, and the first capacitor electrode BMLb may have the same voltage.

Additionally, the second-1 contact hole CNT2-1 and the second-2 contact hole CNT2-2 connected to the second gate layer GAT2 may overlap in plan view. By overlapping the second-1 contact hole CNT2-1 and the second-2 contact hole CNT2-2, pixel integration density may be improved, enabling a high-resolution display device.

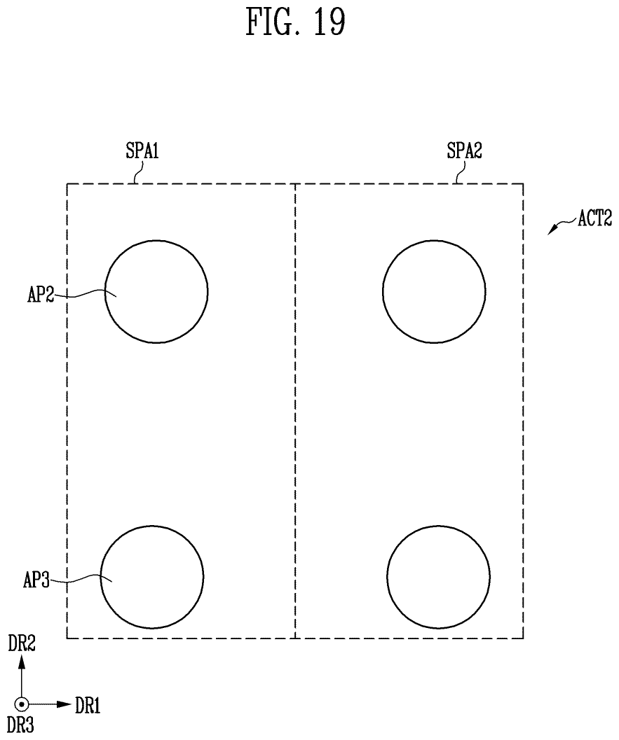

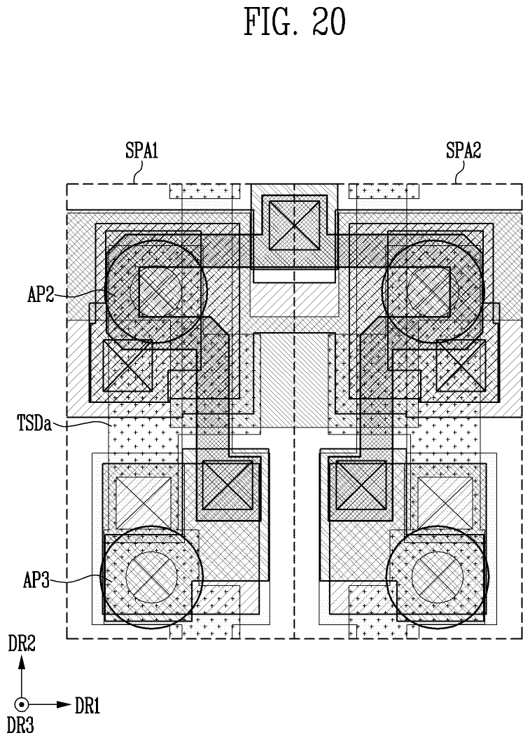

Referring to FIGS. 19 and 20, a second active layer ACT2 may be arranged on the upper conductive layer TSD. The second active layer ACT2 and the first active layer ACT1 may include different materials.

The second active layer ACT2 may include an oxide semiconductor. For example, the second active layer ACT2 may include indium (In), zinc (Zn), gallium (Ga), tin (Sn), titanium (Ti), aluminum (Al), hafnium (Hf), zirconium (Zr), magnesium (Mg), and/or the like. For example, in one or more embodiments, the second active layer ACT2 may include indium-gallium-zinc oxide. The second active layer ACT2 may include a second active pattern AP2 and a third active pattern AP3 arranged in each of the first and second sub-pixel areas SPA1 and SPA2. The second active pattern AP2 and the third active pattern AP3 may each be arranged in an island shape. In the present context and unless defined otherwise, an “island shape” refers to a pattern or a structure that is isolated and distinct, resembling an island. This pattern is surrounded by a different material or space, making it stand out as a separate entity. For example, the active patterns AP2 and AP3 are arranged in such a way that they are isolated from each other and the surrounding areas, much like islands in the sea.

The second active pattern AP2 may overlap with the first lower electrode BSDb and the first opening OP1 of the upper electrode TSDa. The second active pattern AP2 may be connected to the upper electrode TSDa and may also be connected to the first lower electrode BSDb through the first opening OP1. For example, the second active pattern AP2 may directly contact the upper electrode TSDa adjacent to the first opening OP1 and may also directly contact the first lower electrode BSDb through the first opening OP1.

The second active pattern AP2 may form the second transistor T2 of FIG. 2. Because the second transistor T2 is an N-type transistor, the second active pattern AP2 may include a doping region doped with an N-type (kind) dopant.

The third active pattern AP3 may be spaced and/or apart (e.g., spaced apart or separated) from the second active pattern AP2 and may overlap with the second lower electrode BSDc and the second opening OP2 of the upper electrode TSDa. The third active pattern AP3 may be connected to the upper electrode TSDa and may also be connected to the second lower electrode BSDc through the second opening OP2. For example, the third active pattern AP3 may directly contact the upper electrode TSDa adjacent to the second opening OP2 and may also directly contact the second lower electrode BSDc through the second opening OP2.

The third active pattern AP3 may form the third transistor T3 of FIG. 2. Because the third transistor T3 is an N-type transistor, the third active pattern AP3 may include a doping region doped with an N-type (kind) dopant.

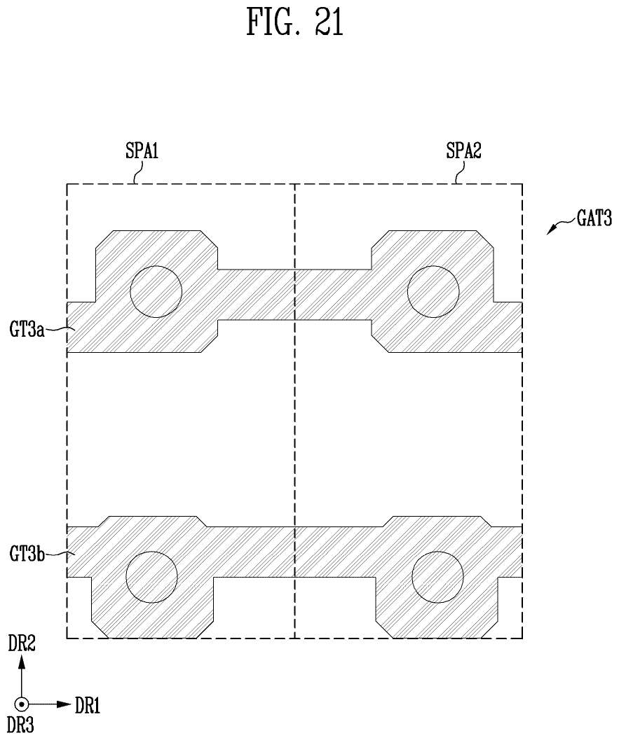

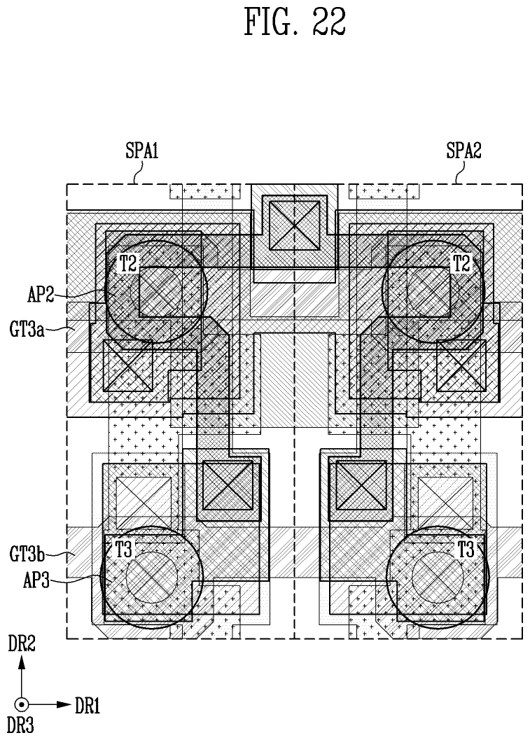

Referring to FIGS. 21 and 22, a third gate layer GAT3 may be arranged on the second active layer ACT2. The third gate layer GAT3 may include a metal, an alloy, a metal nitride, a conductive metal oxide, and/or the like. For example, in one or more embodiments, the third gate layer GAT3 may include a metal such as molybdenum (Mo), aluminum (AI), copper (Cu), or titanium (Ti).

The third gate layer GAT3 may include first and second gate wiring GT3a and GT3b arranged in the first and second sub-pixel areas SPA1 and SPA2.

The first gate wiring GT3a may be connected between the first and second sub-pixel areas SPA1 and SPA2 and may extend to other sub-pixel areas adjacent in the first direction DR1. The first gate wiring GT3a may be provided as the first sub-gate line SGL1 of FIG. 2. For example, the first gate wiring GT3a may be to transmit a first gate signal, which is a write gate signal.

The first gate wiring GT3a may be arranged on the second active pattern AP2 and may overlap with the second active pattern AP2. The overlapping first lower electrode BSDb, upper electrode TSDa, second active pattern AP2, and first gate wiring GT3a may form a second transistor T2.

Because the first lower electrode BSDb, upper electrode TSDa, second active pattern AP2, and first gate wiring GT3a overlap with the first active pattern AP1 and gate electrode GT1a, which form the first transistor T1, the second transistor T2 may overlap with the first transistor T1 on the first transistor T1.

Because the first transistor T1 and the second transistor T2 are arranged in different layers and overlap in plan view, pixel integration density may be improved, enabling a high-resolution display device.

The second gate wiring GT3b may be spaced and/or apart (e.g., spaced apart or separated) from the first gate wiring GT3a in the second direction DR2. The second gate wiring GT3b is connected between the first and second sub-pixel areas SPA1 and SPA2 and may extend to other sub-pixel areas adjacent in the first direction DR1. The second gate wiring GT3b may be provided as the second sub-gate line SGL2 of FIG. 2. For example, the second gate wiring GT3b may be to transmit a second gate signal, which is a compensation gate signal.

The second gate wiring GT3b may be arranged on the third active pattern AP3 and may overlap with the third active pattern AP3. The overlapping second lower electrode BSDc, upper electrode TSDa, third active pattern AP3, and second gate wiring GT3b may form a third transistor T3. Accordingly, the third transistor T3 may be arranged in the same layer as the second transistor T2.

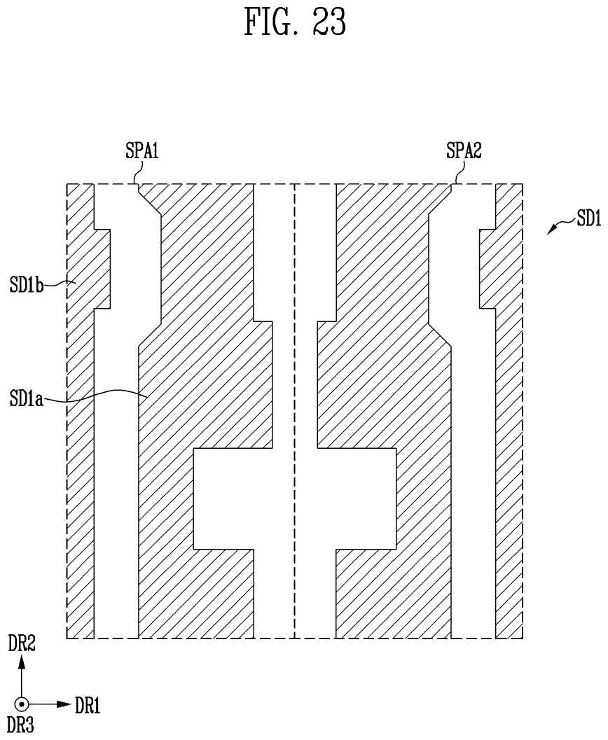

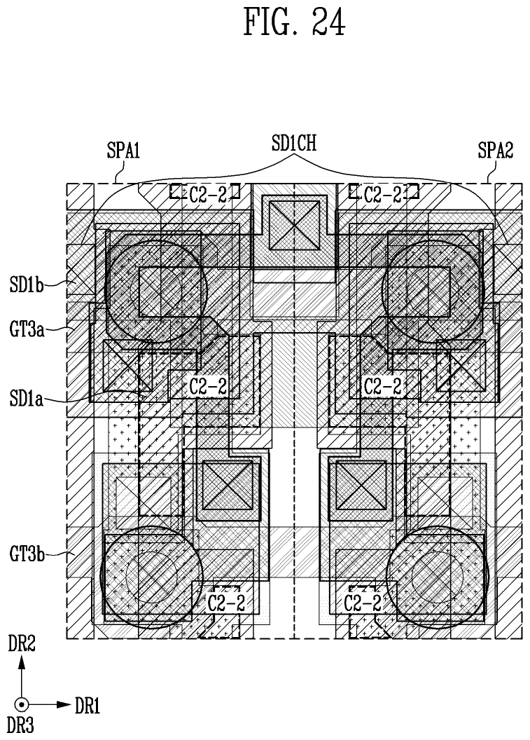

Referring to FIGS. 23 and 24, a first conductive layer SD1 may be arranged on the third gate layer GAT3. The first conductive layer SD1 may include a metal, an alloy, a conductive metal oxide, a transparent conductive material, and/or the like.

The first conductive layer SD1 may include a first power wiring SD1b arranged across a boundary between sub-pixel areas of other pixels adjacent in the first direction DR1, and a data wiring SD1a arranged in each of the first and second sub-pixel areas SPA1 and SPA2.

The first power wiring SD1b may extend in the second direction DR2 and may be arranged at the boundary between the sub-pixel areas of other pixels adjacent in the first direction DR1. The first power wiring SD1b may receive an initialization voltage and transmit the initialization voltage. The first power wiring SD1b may be connected to the second capacitor electrode GT2a included in the second gate layer GAT2 through a contact hole SD1CH. Accordingly, the first power wiring SD1b may apply the initialization voltage to the second capacitor electrode GT2a.

The data wiring SD1a is spaced and/or apart (e.g., spaced apart or separated) from the first power wiring SD1b in the first direction DR1 and may extend in the second direction DR2. The data wiring SD1a may extend to other sub-pixel areas adjacent in the second direction DR2.

The data wiring SD1a may receive a data voltage and transmit the data voltage. For example, because the data wiring SD1a and the first lower metal layer UBML each receive the data voltage, they may have the same voltage.

The data wiring SD1a may overlap with the upper electrode TSDa. The overlapping upper electrode TSDa and the data wiring SD1a may form second-2 capacitors C2-2. The second-2 capacitors C2-2 may form part of the second capacitor C2 of FIG. 2. In this regard, the upper electrode TSDa and the data wiring SD1a may receive different voltages, respectively, resulting in a voltage difference between the upper electrode TSDa and the data wiring SD1a. A charge may be stored in each of the second-2 capacitors C2-2 in proportion to this voltage difference.

In addition, the first connection electrode GT2b included in the second gate layer GAT2 may be connected to the first capacitor electrode BMLb included in the second lower metal layer BML through the second-1 contact hole CNT2-1, and may be connected to the upper electrode TSDa included in the upper conductive layer TSD through the second-2 contact hole CNT2-2. As a result, the upper electrode TSDa may be electrically connected to the first capacitor electrode BMLb included in the second lower metal layer BML through the first connection electrode GT2b. Therefore, the upper electrode TSDa, the first connection electrode GT2b, and the first capacitor electrode BMLb may have the same voltage.

Accordingly, the second-1 capacitor C2-1 and the second-2 capacitor C2-2 may be connected in parallel to form a single second capacitor. In this regard, the second capacitor may be provided as the second capacitor C2 of FIG. 2. Because the second-1 capacitor C2-1 and the second-2 capacitor C2-2 are connected in parallel, the second capacitor may have a capacitance equal to the sum of the capacitance of the second-1 capacitor C2-1 and the capacitance of the second-2 capacitor C2-2.

In one or more embodiments, because the second capacitor includes (e.g., consists of) a plurality of capacitors connected in parallel, the capacitance of the second capacitor may be increased. When the data voltage is applied to the sub-pixel, it may be transmitted to the gate electrode of the first transistor T1 in the ratio of (the capacitance of the second capacitor)/(the capacitance of the first capacitor+the capacitance of the second capacitor). For example, as the capacitance of the second capacitor increases, the transmission rate of the data voltage may be improved. In addition, as the capacitance of the second capacitor increases, the variation in the transmission rate of the data voltage may be minimized or reduced.

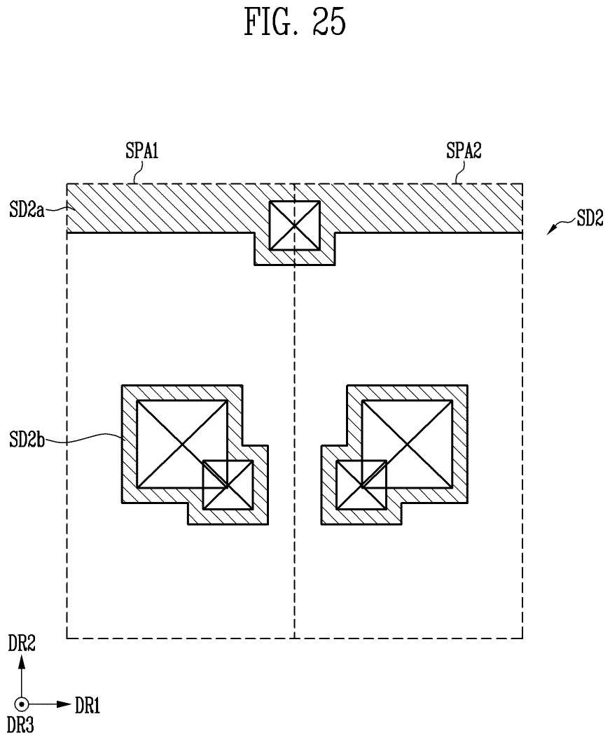

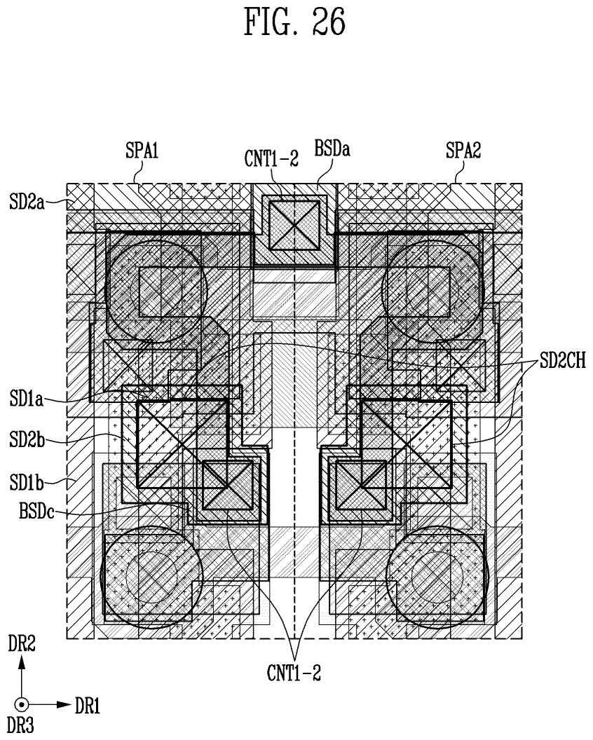

Referring to FIGS. 25 and 26, a second conductive layer SD2 may be arranged on the first conductive layer SD1. The second conductive layer SD2 may include a metal, an alloy, a conductive metal oxide, a transparent conductive material, and/or the like.

The second conductive layer SD2 may include a second power wiring SD2a arranged in the first and second sub-pixel areas SPA1 and SPA2 and a third connection electrode SD2b arranged in each of the first and second sub-pixel areas SPA1 and SPA2.

The second power wiring SD2a is connected between the first and second sub-pixel areas SPA1 and SPA2 and may extend to other sub-pixel areas adjacent in the first direction DR1. The second power wiring SD2a may be connected to the second connection electrode BSDa included in the lower conductive layer BSD through a first-2 contact hole CNT1-2.

The second power wiring SD2a may receive a first power voltage and transmit the first power voltage. In this regard, the first power voltage may refer to the first power voltage transmitted through the first power voltage node VDDN of FIG. 2.

The third connection electrode SD2b may be spaced and/or apart (e.g., spaced apart or separated) from the second power wiring SD2a. The third connection electrode SD2b may be arranged in an island shape. The third connection electrode SD2b may be connected to the second lower electrode BSDc of the lower conductive layer BSD through the first-2 contact hole CNT1-2. Additionally, the third connection electrode SD2b may be connected to an anode electrode, which will be described in more detail later, through a contact hole SD2CH.

The second conductive layer SD2 and the lower conductive layer BSD may be connected to each other through at least one first-2 contact hole CNT1-2. For example, in one or more embodiments, the second power wiring SD2a is connected to the second connection electrode BSDa through the first-2 contact hole CNT1-2, and the third connection electrode SD2b is also connected to the second lower electrode BSDc through the first-2 contact hole CNT1-2. Thus, in the first and second sub-pixel areas SPA1 and SPA2 included in a pixel, the second conductive layer SD2 and the lower conductive layer BSD may be connected to each other through three first-2 contact holes CNT1-2. As a result, the lower conductive layer BSD may be connected to the first active layer ACT1 through the first-1 contact holes CNT1-1, and to the second conductive layer SD2 through the first-2 contact holes CNT1-2.

For example, the second power wiring SD2a is connected to the second connection electrode BSDa included in the lower conductive layer BSD through the first-2 contact hole CNT1-2, and the second connection electrode BSDa is connected to the first active pattern AP1 through the first-1 contact hole CNT1-1, allowing the first power voltage to be transmitted from the second power wiring SD2a to the first active layer ACT1.

In addition, the third connection electrode SD2b is connected to the second lower electrode BSDc included in the lower conductive layer BSD through the first-2 contact hole CNT1-2, and the second lower electrode BSDc is connected to the first active pattern AP1 through the first-1 contact hole CNT1-1. As a result, the anode electrode (anode electrode AE of FIG. 2), the second lower electrode BSDc, and the first active pattern AP1 may be electrically connected to each other. As a result, the light-emitting element including the first transistor T1 and the anode electrode may be electrically connected, and the light-emitting element including the third transistor T3 and the anode electrode may also be electrically connected.

Furthermore, the first-1 contact hole CNT1-1 and the first-2 contact hole CNT1-2, which are connected to the lower conductive layer BSD, may overlap in plan view. By overlapping the first-1 contact hole CNT1-1 and the first-2 contact hole CNT1-2, pixel integration density may be improved, enabling a high-resolution display device. In the present context and unless defined otherwise, plan view refers to a view from above, looking down on an object or layout. In technical drawings, it is an orthographic projection that shows the arrangement of components as seen from above, providing a clear layout of how different elements are positioned relative to each other.

The anode electrode may be arranged on the second conductive layer SD2. The anode electrode may include a metal, an alloy, a conductive metal oxide, a transparent conductive material, and/or the like.

The anode electrode may be provided in each of the first and second sub-pixel areas SPA1 and SPA2. The anode electrode may be provided as the anode electrode AE of FIG. 2. The anode electrode may form part of the light-emitting element of FIG. 2.

The anode electrode may be connected to the third connection electrode SD2b through the contact hole SD2CH. Through this connection, the anode electrode may be electrically connected to the first transistor T1 and the third transistor T3.

At least one insulating layer may be arranged between each layer, from the first lower metal layer UBML to the anode electrode. Therefore, except for the contact hole portions, each layer may be insulated from one another, and overlapping electrodes applied with different voltages may form transistors or capacitors.

In one or more embodiments, if (e.g., when) the first transistor including poly-silicon and the second transistor including an oxide semiconductor overlap each other, and contact holes that are arranged on different layers and share the same electrodes to connect electrically corresponding electrodes overlap each other (e.g., first-1 contact hole CNT1-1 and first-2 contact hole CNT1-2, or second-1 contact hole CNT2-1 and second-2 contact hole CNT2-2), pixel integration density may be improved, allowing the implementation of a high-resolution display device.

Furthermore, by increasing the capacitance of the second capacitor connected to the data wiring SD1a that transmits the data voltage, the transmission rate of the data voltage transmitted to the first transistor T1 may be improved, and the variation in the transmission rate of the data voltage may be minimized or reduced.

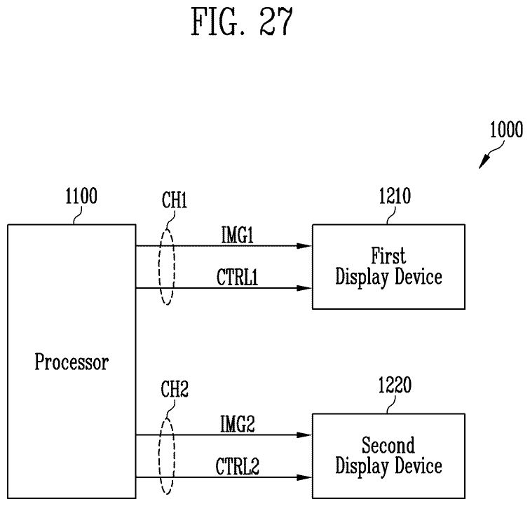

FIG. 27 is a block diagram illustrating a display system according to one or more embodiments of the present disclosure.

Referring to FIG. 27, a display system 1000 may include a processor 1100 and one or more display devices 1210, 1220.

The processor 1100 may perform one or more suitable tasks and calculations. In one or more embodiments, the processor 1100 may include an application processor, a graphic processor, a microprocessor, a central processing unit (CPU), and/or the like. The processor 1100 may be connected to and control other components of the display system 1000 via a bus system.

In FIG. 27, the display system 1000 is illustrated as including first and second display devices 1210 and 1220. The processor 1100 may be connected to the first display device 1210 via a first channel CH1 and to the second display device 1220 via a second channel CH2.

Through the first channel CH1, the processor 1100 may be to transmit first image data IMG1 and first control signals CTRL1 to the first display device 1210. The first display device 1210 may display an image based on the first image data IMG1 and the first control signals CTRL1. The first display device 1210 may be configured in substantially the same manner as the display device DD described with reference to FIG. 1. In this case, the first image data IMG1 and the first control signals CTRL1 may be provided as the input image data IMG and control signals CTRL of FIG. 1, respectively.

Through the second channel CH2, the processor 1100 may be to transmit second image data IMG2 and second control signals CTRL2 to the second display device 1220. The second display device 1220 may display an image based on the second image data IMG2 and the second control signals CTRL2. The second display device 1220 may be configured in substantially the same manner as the display device DD described with reference to FIG. 1. In this case, the second image data IMG2 and the second control signals CTRL2 may be provided as the input image data IMG and control signals CTRL of FIG. 1, respectively.

The display system 1000 may include computing systems that provide image display functionality, such as a portable computer, mobile phone, smart phone, tablet personal computer (PC), smart watch, watch phone, portable multimedia player (PMP), navigation system, or ultra-mobile personal computer (UMPC). Additionally, the display system 1000 may include at least one of a head-mounted display (HMD), virtual reality (VR) device, mixed reality (MR) device, or augmented reality (AR) device.

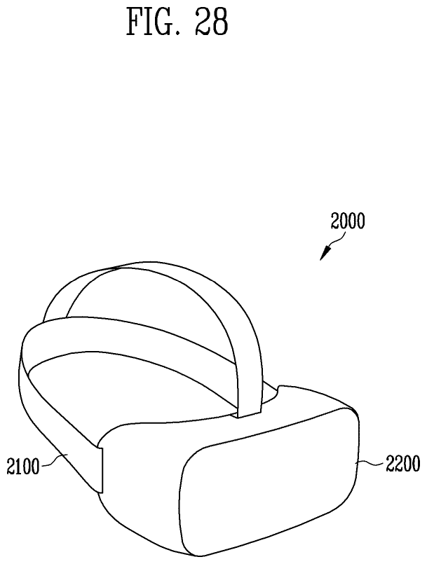

FIG. 28 is a perspective view illustrating an application example of the display system of FIG. 27 according to one or more embodiments of the present disclosure.

Referring to FIG. 28, in one or more embodiments, the display system 1000 of FIG. 27 may be applied to a head-mounted display device 2000. The head-mounted display device 2000 may be a wearable electronic device that can be worn on a user's head.

The head-mounted display device 2000 may include a head-mounted band 2100 and a display device housing case 2200. The head-mounted band 2100 may be connected to the display device housing case 2200. The head-mounted band 2100 may include a horizontal band and/or a vertical band to secure the head-mounted display device 2000 to the user's head. The horizontal band may be configured to be around (e.g., surround) the sides of the user's head, and the vertical band may be configured to be around (e.g., surround) the top of the user's head. However, embodiments of the present disclosure are not limited thereto. For example, in one or more embodiments, the head-mounted band 2100 may be implemented in the form of eyeglass frames, a helmet, or other shapes.

The display device housing case 2200 may house the first and second display devices 1210 and 1220 of FIG. 27. The display device housing case 2200 may further house the processor 1100 of FIG. 27.

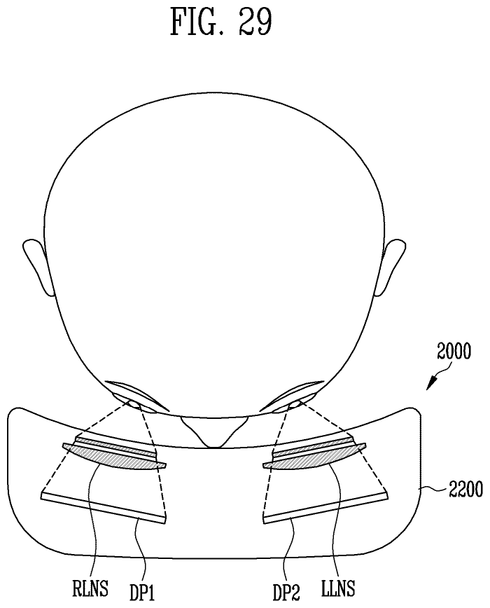

FIG. 29 is a view showing the head-mounted display device of FIG. 28 worn by a user according to one or more embodiments of the present disclosure.

Referring to FIG. 29, inside the head-mounted display device 2000, a first display panel DP1 of a first display device 1210 (see FIG. 27) and a second display panel DP2 of a second display device 1220 (see FIG. 27) are arranged. The head-mounted display device 2000 may further include one or more lenses LLNS and RLNS.

Inside the display device housing case 2200, a right lens RLNS may be arranged between the first display panel DP1 and the user's right eye. Inside the display device housing case 2200, a left lens LLNS may be arranged between the second display panel DP2 and the user's left eye.

In one or more embodiments, the image output from the first display panel DP1 may be shown to the user's right eye through the right lens RLNS. The right lens RLNS may refract light from the first display panel DP1 toward the user's right eye. The right lens RLNS may perform an optical function to adjust the viewing distance between the first display panel DP1 and the user's right eye.

In one or more embodiments, the image output from the second display panel DP2 may be shown to the user's left eye through the left lens LLNS. The left lens LLNS may refract light from the second display panel DP2 toward the user's left eye. The left lens LLNS may perform an optical function to adjust the viewing distance between the second display panel DP2 and the user's left eye.

In one or more embodiments, each of the right lens RLNS and the left lens LLNS may include an optical lens with a pancake-shaped cross-section. In one or more embodiments, each of the right lens RLNS and the left lens LLNS may include a multi-channel lens with sub-regions having different optical properties. In these embodiments, each display panel may output images corresponding to each of the sub-regions of the multi-channel lens, and the output images may each pass through the sub-regions to be viewed to the user.

According to one or more embodiments of the present disclosure, the display device may be applied to one or more electronic devices. The electronic device may include one or more selected from among televisions, monitors, outside billboards, personal computers, laptop computers, personal digital terminals, display devices for automobiles, game consoles, portable electronic devices, Internet of Things devices, cameras, mobile phones, smartphones, tablet computers, mobile communication terminals, electronic notebooks, electronic books, portable multimedia players, navigation devices, ultra-mobile personal computers, smartwatches, watch phones, head-mounted display devices, virtual reality devices, mixed reality devices, and augmented reality devices.

In the context of the present application and unless otherwise defined, the terms “use,” “using,” and “used” may be considered synonymous with the terms “utilize,” “utilizing,” and “utilized,” respectively.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

The display device, the electronic devices/apparatus, the display device-manufacturing apparatus, or any other relevant apparatuses/devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While certain technical aspects of the disclosure have been described in more detail according to the above embodiments, it should be noted that the embodiments are for illustrative purposes and not for limiting the present disclosure. A person of ordinary skill in the art would understand that one or more suitable modifications are possible within the scope of the technical concept of the disclosure.

The scope of the disclosure should not be limited to the content described in the detailed description of the disclosure, but should be defined by the claims and equivalents thereof. All modifications or variations derived from the meaning and scope of the claims, and their equivalents, should be interpreted as being included within the scope of the disclosure.

What is claimed is:

1. A display device, comprising:
a substrate;
a first transistor on the substrate;
a second transistor on the first transistor and overlapping the first transistor; and
an anode electrode on the second transistor and connected to the first transistor,
wherein the first transistor comprises:
a first active pattern on the substrate; and
a gate electrode on the first active pattern and overlapping the first active pattern, and
wherein the second transistor comprises:
a first lower electrode on the gate electrode;
an upper electrode on the first lower electrode and comprising a first opening that overlaps the first lower electrode;
a second active pattern on the upper electrode and connected to the first lower electrode through the first opening; and
a first gate wiring on the second active pattern and overlapping the second active pattern.

2. The display device of claim 1, wherein:
the first active pattern comprises low-temperature poly-silicon, and
the second active pattern comprises an oxide semiconductor.

3. The display device of claim 1, further comprising:
a first active layer comprising the first active pattern;
a first gate layer comprising the gate electrode;
a second gate layer between the first gate layer and the first lower electrode;
a lower conductive layer comprising the first lower electrode;
an upper conductive layer comprising the upper electrode;
a second active layer comprising the second active pattern; and
a third gate layer comprising the first gate wiring.

4. The display device of claim 3, further comprising:
a third transistor in the same layer as the second transistor.

5. The display device of claim 4, wherein the third transistor comprises:
a second lower electrode in the lower conductive layer and spaced from the first lower electrode;
the upper electrode on the second lower electrode and comprising a second opening that overlaps the second lower electrode;
a third active pattern in the second active layer, spaced from the second active pattern, connected to the second lower electrode through the second opening, and comprising an oxide semiconductor; and
a second gate wiring in the third gate layer, spaced from the first gate wiring, and overlapping the third active pattern.

6. The display device of claim 3, wherein:
the second gate layer overlaps the gate electrode; and
the overlapping gate electrode and second gate layer constitute a first capacitor.

7. The display device of claim 6, wherein:
the second gate layer overlaps the first lower electrode; and
the overlapping second gate layer and first lower electrode constitute a second capacitor.

8. The display device of claim 7, wherein the first lower electrode and the gate electrode are connected to each other.

9. The display device of claim 3, further comprising:
a first conductive layer on the third gate layer and comprising a power wiring for transmitting an initialization voltage and a data wiring for transmitting a data voltage.

10. The display device of claim 9, further comprising:
a second conductive layer between the first conductive layer and the anode electrode.

11. The display device of claim 10, wherein the lower conductive layer is connected to the first active layer through at least one first contact hole, and is connected to the second conductive layer through at least one second contact hole.

12. The display device of claim 11, wherein the first contact hole and the second contact hole overlap each other.

13. The display device of claim 9, wherein:
the data wiring overlaps the upper electrode; and
the overlapping upper electrode and data wiring constitute a third capacitor.

14. The display device of claim 13, further comprising:
a first lower metal layer between the substrate and the first active layer; and
a second lower metal layer between the first lower metal layer and the first active layer.

15. The display device of claim 14, wherein:
the first lower metal layer and the second lower metal layer overlap each other; and
the overlapping first and second lower metal layers constitute a fourth capacitor.

16. The display device of claim 15, wherein:
the first lower metal layer is configured to receive a data voltage; and
the second lower metal layer is electrically connected to the upper conductive layer through the second gate layer.

17. The display device of claim 16, wherein the second gate layer is connected to the second lower metal layer through a third contact hole, and connected to the upper conductive layer through a fourth contact hole.

18. The display device of claim 17, wherein the third contact hole and the fourth contact hole overlap each other.

19. A pixel comprising:
a first transistor connected between a first power voltage node, to which a first power voltage is applied, and a first node, and having a gate electrode connected to a second node;
a second transistor connected between the second node and a third node, and having a gate electrode connected to a first gate line to which a first gate signal is applied;
a third transistor connected between the third node and the first node, and having a gate electrode connected to a second gate line to which a second gate signal is applied;
a first capacitor connected between an initialization voltage node, to which an initialization voltage is applied, and the second node;
a second capacitor connected between a data line, to which a data signal is applied, and the third node; and
a light-emitting element connected between the first node and a second power voltage node, to which a second power voltage is applied,
wherein the first transistor is a P-type transistor, and the second transistor and the third transistors are each an N-type transistor.

20. An electronic device, comprising:
a processor to provide input image data; and
a display device to display an image based on the input image data, the display device comprising:
a substrate;
a first transistor on the substrate;
a second transistor on the first transistor and overlapping the first transistor; and
an anode electrode on the second transistor and connected to the first transistor,
wherein the first transistor comprises:
a first active pattern on the substrate; and
a gate electrode on the first active pattern and overlapping the first active pattern, and
wherein the second transistor comprises:
a first lower electrode on the gate electrode;
an upper electrode on the first lower electrode and comprising a first opening that overlaps the first lower electrode;
a second active pattern on the upper electrode and connected to the first lower electrode through the first opening; and
a first gate wiring on the second active pattern and overlapping the second active pattern.
